(19) United States
(12) Patent Application Publication
(10) Pub. No.: US 2026/0247318 A1
(43) Pub. Date: Aug. 20, 2026

(54) METHODS AND APPARATUSES FOR HANDLING OF NETWORK FUNCTIONS DEPLOYED IN A CUSTOMER PREMISE NETWORK

(71) Applicant: INTERDIGITAL PATENT HOLDINGS, INC., Wilmington, DE (US)

(72) Inventors: Antonio DE LA OLIVA, Madrid (ES); Debashish PURKAYASTHA, Eagleville, PA (US); Robert GAZDA, Spring City, PA (US); Ulises OLVERA-HERNANDEZ, Saint-Lazare (CA); Michael STARSINIC, Newtown, PA (US)

(21) Appl. No.: 19/160,997

(22) PCT Filed: Mar. 1, 2024
(86) PCT No.: PCT/US2024/018118

§ 371 Date: Aug. 29, 2025

Related U.S. Application Data
(60) Provisional application No. 63/449,737, filed on Mar. 3, 2023.

(51) Int. Cl. H04W 60/00; H04W 8/20

(52) U.S. Cl. CPC H04W 60/00; H04W 8/20

(57) ABSTRACT

Methods, apparatuses, and procedures are disclosed herein for handling of network functions (NFs) deployed in a customer premise network (CPN) in wireless communications. For example, a wireless transmit/receive unit (WTRU) is configured to send, to an access and mobility management function (AMF), a first registration message indicating a request for the AMF to proxy register a network function (NF) or an NF group associated with the WTRU. The WTRU is further configured to receive, from the AMF, a second registration message indicating proxy registration information based on the first registration message, and send, to the AMF, a message indicating NF profile information of the NF or the NF group associated with the WTRU.

### CROSS-REFERENCE TO RELATED APPLICATION(S)

This application claims priority to and the benefit of U.S. Provisional Application No. 63/449,737 filed in the U.S. Patent and Trademark Office on Mar. 3, 2023, the entire content of which being incorporated herein by reference as if fully set forth below in its entirety and for all applicable purposes.

### FIELD

Mobile communications using wireless communication continue to evolve. A fifth generation may be referred to as 5G. A previous (legacy) generation of mobile communication may be, for example, fourth generation (4G) long term evolution (LTE). Embodiments disclosed herein generally relate to communication networks.

### SUMMARY

One or more embodiments disclosed herein are related to methods, apparatuses, and procedures for handling of network functions (NFs) deployed in a customer premise network (CPN) in wireless communications.

In one embodiment, a method implemented by a wireless transmit and/or receive unit (WTRU) for wireless communications includes sending, to an access and mobility management function (AMF), a first registration message indicating a request for the AMF to proxy register a network function (NF) or an NF group associated with the WTRU, and receiving, from the AMF, a second registration message indicating proxy registration information based on the first registration message. The method also includes sending, to the AMF, a message indicating NF profile information of the NF or the NF group associated with the WTRU.

In one embodiment, a wireless transmit/receive unit (WTRU) for wireless communications comprises circuitry, including a processor, a transmitter, a receiver, and/or memory is provided. The WTRU is configured to send, to an access and mobility management function (AMF), a first registration message indicating a request for the AMF to proxy register a network function (NF) or an NF group associated with the WTRU. The WTRU is further configured to receive, from the AMF, a second registration message indicating proxy registration information based on the first registration message, and send, to the AMF, a message indicating NF profile information of the NF or the NF group associated with the WTRU.

In one embodiment, a device (e.g., a wireless transmit/receive unit (WTRU)) may include a processor configured to perform one or more actions. The device may send a registration message to an access and mobility management function (AMF), wherein the registration message indicates a request for the AMF to proxy register a network function (NF) or an NF group associated with the device. The device may receive a registration accept message from the AMF. The device may send an NF profile message to the AMF, wherein the NF profile message indicates NF profile information for the NF or the NF group associated with the device. The device may establish a protocol data unit (PDU) session. The device my receive an internet protocol (IP) address assignment.

In one embodiment, a network device (e.g., an AMF) may include a processor configured to perform one or more actions. The device may receive a registration message from a WTRU, wherein the registration message indicates a request for the network device to proxy register a network function (NF) or an NF group associated with the WTRU. The device may send a registration accept message to the WTRU. The device may receive a network function (NF) profile message from the WTRU, wherein the NF profile message indicates NF profile information for the NF or the NF group associated with the WTRU. The device may receive an internet protocol (IP) address assignment, wherein the IP address assignment indicates IP address information associated with the WTRU. The device may update the NF profile information based on the IP address information. The device may perform proxy registration for the NF or the NF group associated with the WTRU based on the updated NF profile information.

In one embodiment, the request may be for the NF group. The NF group may be a plurality of NFs. The NF profile message may indicate the NF group and a parameter that is common to the plurality of NFs in the NF group. The parameter may include at least one of: a fully qualified domain name (FQDN) associated with the WTRU, or an IP address indicated by the IP address assignment.

In one embodiment, the WTRU may be associated with a split customer premise network (CPN). The NF profile message may indicate a plurality of local network exposure functions (L-NEFs) associated with the split CPN and priority information associated with the plurality of L-NEFs. The NF profile message may be sent via an uplink non-access stratum (NAS) transport message.

In one embodiment, the WTRU may be associated with an evolved Residential Gateway (eRG). The WTRU, the NF, and/or the NF group may be associated with one or more of: a local network registration function (L-NRF), a local network exposure function (L-NEF), or a local network data analytics function (L-NWDAF). The WTRU and the NF or NF group may be associated with a local network. The local network may be a customer premise network (CPN).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example of a customer premise network (CPN) architecture, according to one or more embodiments;

FIG. 3 is a system diagram illustrating an example of an evolved Residential Gateway (eRG) architecture, according to one or more embodiments;

FIG. 4 is a message flow diagram illustrating an example procedure of network function (NF) group registration, according to one or more embodiments;

FIG. 5 is a message flow diagram illustrating an example procedure of proxy registration of CPN-deployed NFs via an access and mobility management function (AMF), according to one or more embodiments; and

FIG. 6 is a system diagram illustrating an example of a split CPN architecture, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System, Networks, and Devices

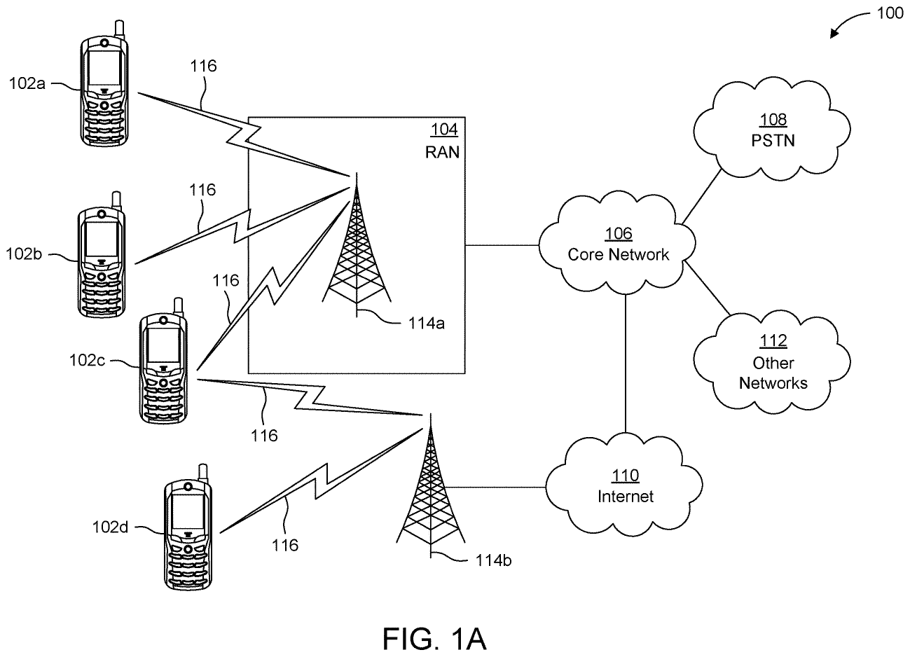

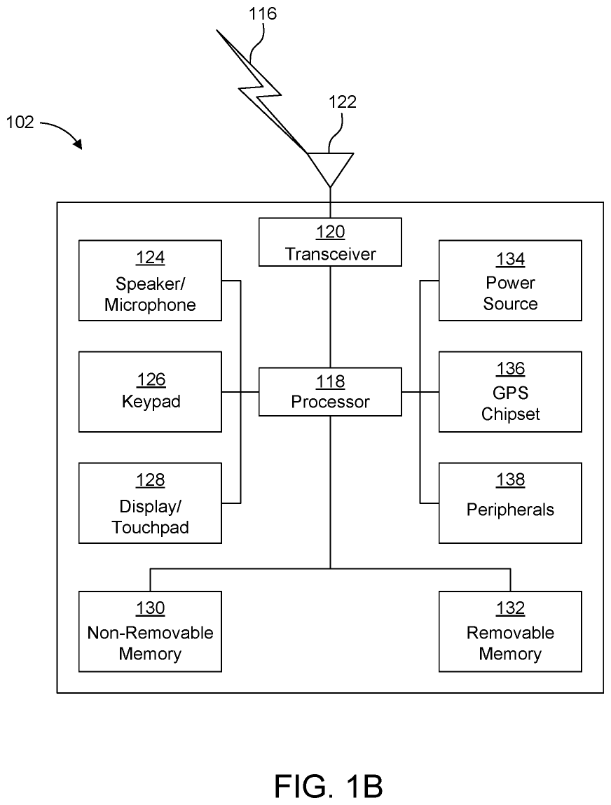

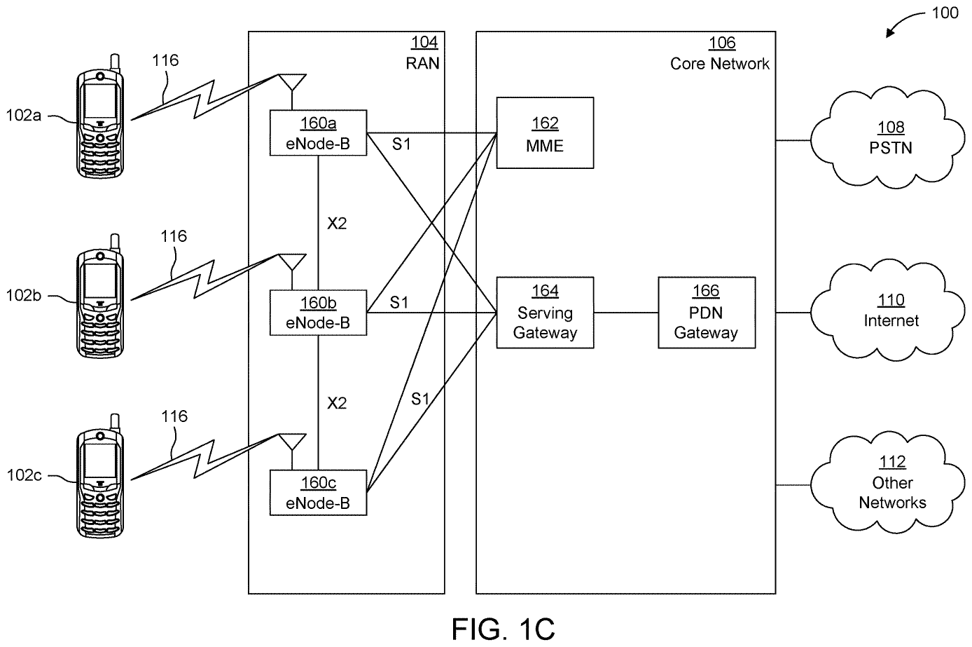

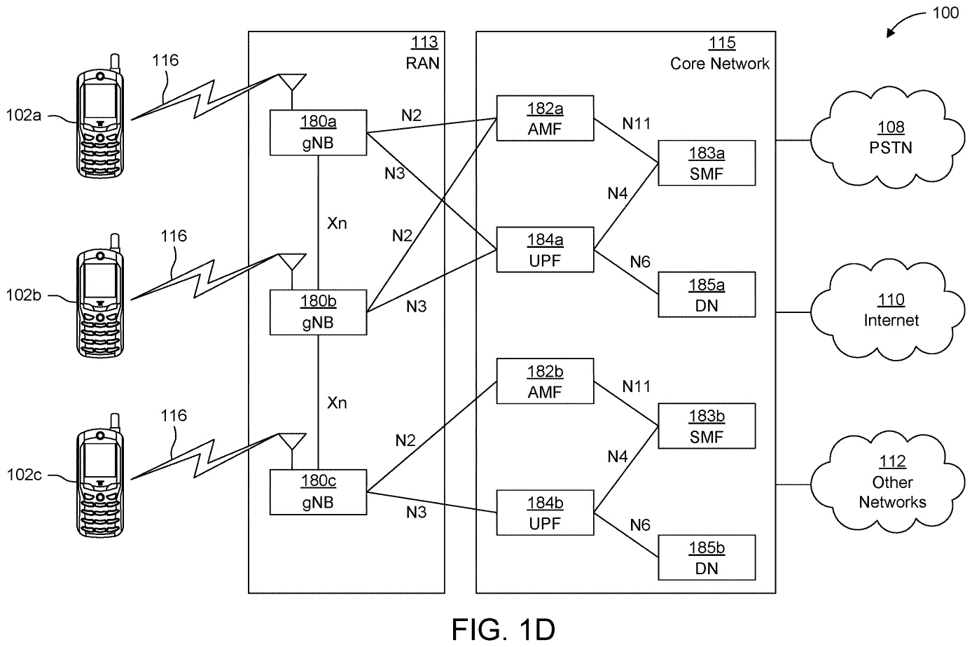

The methods, procedures, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

Feature(s) associated with localized networks (e.g., 5G Residential, Customer-Premise Network (CPN), and/or the like) are provided herein.

Feature(s) associated with an evolved Residential Gateway (eRG) Architecture are provided herein. Feature(s) associated with CPN-deployed network functions (NFs) are provided herein. A network function may refer to a processing function in a network (e.g., which has defined functional behavior and (pre)defined interfaces). A network function may be implemented as a network element on a dedicated hardware, as a software instance running on a dedicated hardware, or as a virtualized function instantiated on an appropriate platform (e.g. on a cloud infrastructure).

Feature(s) associated with NF group-based registration, update, and notifications (e.g., associated with a user plane) are provided herein.

Feature(s) associated with proxy-registration of NFs co-located with an eRG via an access and mobility management function (AMF) (e.g., associated with a control plane) are provided herein.

Feature(s) associated with NF profile enhancements to support split CPNs are provided herein.

Feature(s) associated with CPNs are provided herein.

CPNs are a type of local network. CPNs may extend network management capabilities (e.g., 3GPP network management capabilities) into customer premises (e.g., homes, offices, shops, etc.). CPNs may provide improved quality of service to users.

CPNs may be described as an evolution of a 5^{th} Generation (5G)-Residential Gateway concept. The 5G Residential Gateway may involve a residential base station (e.g., a premise radio access station (PRAS)) and an evolved Residential Gateway (eRG) being deployed together (e.g., with non-3GPP devices).

A “locally-deployed NF” may be an NF that is deployed in a local network (e.g., a CPN) and uses an eRG to communicate with functions that are deployed outside of the local network (e.g., in the 5GS). A “locally-deployed application function (AF)” may be an AF that is deployed in a local network (e.g., a CPN) and uses an eRG to communicate with functions that are deployed outside of the local network (e.g., in the 5GS). As used herein, the terms “CPN” and “local network” may be interchangeable. A locally-deployed NF, or a locally-deployed AF, may be hosted (or co-located) within the eRG or may be hosted in a device (e.g., within the local network) that is separate from the eRG and that has a communication path to the eRG. In such a case, locally-deployed NFs may (e.g., still) communicate with functions outside the local network via the eRG.

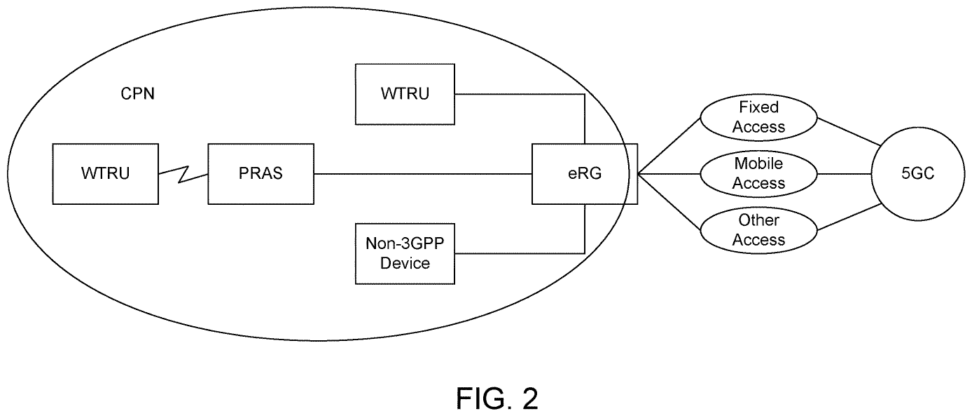

FIG. 2 illustrates an example architecture for a CPN.

The eRG may be a gateway (e.g., anchor) element that connects different devices (e.g., all the different devices, for example 3GPP and non3GPP devices) in the CPN to the 5G core (5GC). The eRG may be connected to the 5GC through different mechanisms. For example, the eRG may be connected to the 5GC through 5G Mobile Access (e.g., 5G-RAN) or through Fixed Access (e.g., including using both mobile and fixed access together).

The eRG may be considered as a UE from the perspective of the 5GC (e.g., regardless of whether the eRG is connecting through 5G-RAN or Fixed Access). For example, the eRG may exchange N1 signaling with the 5GC (e.g., communicate via the N1 interface). The eRG may include a WTRU (e.g., may communicate via wireless messaging). The eRG may communicate via a wired connection. Feature(s) described herein that relate to an eRG that wirelessly communicates with the 5GC (e.g., via a WTRU) may similarly apply to an eRG that communicates with the 5GC via a wired connection (e.g., via fixed wire access), and vice versa.

Feature(s) associated with CPN ownership and administration are provided herein. An end-user or another third party entity (e.g., enterprise, building owner, landlord, or other third party provider) may be authorized to (e.g., at least partially) configure and manage a network node in a CPN (e.g., a PRAS, an eRG, and CPN-connected devices), as an authorized administrator. A CPN may be owned, installed, and/or (e.g., at least partially) configured by the customer (e.g., end-user or other 3rd party) of a public network operator (MNO).

Example use cases for CPNs are provided herein.

Feature(s) associated with quality of service (QoS) for small indoor base station connectivity are provided herein. QoS flows may be provided to WTRUs behind an eRG (e.g., connected to PRAS or non-3GPP access).

Feature(s) associated with visitor access to a small indoor base station are provided herein. Access may be provided to visiting WTRUs, allowing them to connect to the PRAS or non-3GPP access and to the 5GC through the eRG. Isolation of traffic, different charging sessions, etc., may be considered.

Feature(s) associated with QoS maintenance from outdoor to indoor are provided herein. WTRUs may perform handover between gNB's and PRAS or non-3GPP accesses (e.g., and CPNs may maintain QoS of the flows).

Feature(s) associated with efficient routing for WTRU-to-WTRU communications via a residential gateway (e.g., an eRG) are provided herein. One or more (e.g., two) WTRUs connected to different or the same PRAS or non-3GPP access may be routed (e.g., efficiently) within the CPN.

Feature(s) associated with end-to-end (E2E) QoS monitoring are provided herein. The E2E QoS may be monitored when some of the segments traversed by the traffic are within the CPN.

Feature(s) associated with provisioning eRGs and PRASs are provided herein. Operator-managed parts of the CPN may be automatically provisioned.

Feature(s) associated with 5G LAN scalability are provided herein. The wide use of 5G-LAN connectivity may test the limits of current VLAN scalability support within 3GPP networks.

Feature(s) associated with indoor LAN to 5G LAN connectivity are provided herein. WTRUs and non-3GPP devices belonging to the same network may interact. eRGs may support this interoperability.

Feature(s) associated with seamless path switching from a WTRU-to-WTRU direct communication to an indirect communication via an eRG are provided herein. Paths may be set up between one or more (e.g., two) WTRUs attached to PRAS of the same CPN. The eRG may create paths (e.g., more efficient paths) between them.

Feature(s) associated with seamless switching from a service hosting environment to an application server via an eRG are provided herein. The eRG and local Application Services may interact. Computation may be offloaded to the local AS.

Feature(s) associated with local control of connectivity of WTRUs in a CPN are provided herein. This use case tackles how the authorized administrator can configure explicitly QoS guarantees for flows between specific WTRUs.

Feature(s) associated with IP traffic offload are provided herein. The eRG may offload certain flows directly to an external IP network locally.

Feature(s) associated with PRAS sharing are provided herein. This use case studies the shared use of different PRAS in a CPN by visiting WTRUs from different operators.

Feature(s) associated with multicast service access control for legacy device(s) behind an eRG are provided herein. Feature(s) associated with multicast traffic access behind an eRG are provided herein. The granularity of multicast service access control may be at the eRG level (e.g., so devices behind the eRG share all the same access rights). This access control granularity may be enhanced.

Feature(s) associated with connection of 5G LAN with fixed IP VPN are provided herein. Users in the 5G-LAN may be interpolated with external IP VPNs (e.g., such as VPNs used for home working).

Feature(s) associated with loss of connectivity between eRG or PRAS and the 5GC are provided herein. The CPN may take one or more actions if the eRG loses connectivity to the 5GC.

Feature(s) associated with control of CPNs by an authorized administrator are provided herein, the (e.g., different) configurations of the CPN (e.g., including eRG) may be controlled by an external authorized administrator (e.g., either remotely or locally).

Feature(s) associated with eRG supporting multiple connectivity are provided herein. There may be routing scenarios where the eRG has multiple connections to the 5GC (e.g., which may be similar to the hybrid access for the eRG).

Feature(s) associated with providing 5G multicast-broadcast services (5MBS) for devices through an eRG are provided herein. 5MBS services may be provisioned to devices behind an eRG.

Feature(s) associated with identification, authentication, and authorization for PRASs are provided herein. The link between the PRAS and the eRG may be secured.

Feature(s) associated with supporting external services behind eRG in CPN are provided herein. The 5GC may be used as an identity provider for services to nodes in the CPN.

CPNs may have one or more requirements (e.g., from the service perspective).

The 5G system may support applications on an AS connected to a CPN.

The 5G system may enable the network operator associated with an eRG to control the security policy of the eRG.

The 5G system may support real time E2E QoS monitoring and control for intra-CPN data traffic (e.g., any intra-CPN data traffic) to or from a WTRU (e.g., via eRG or via PRAS and eRG).

The 5G system may support real time E2E QoS monitoring and control for data traffic (e.g., any data traffic) between a WTRU within a CPN and the 5G network (i.e., via eRG or via PRAS)

The 5G system may (e.g., subject to operated policy) enable the authorized administrator to provision a PRAS with WTRU access considerations (e.g., allowing all WTRUs, or allowing specific WTRUs only).

The 5G system may enable the network operator to provide 5G services (e.g., any 5G services) to a WTRU (e.g., any WTRU) via a PRAS connected via an eRG.

The 5G system may support a mechanism to enable authorized third parties to authorize and/or deauthorize WTRUs to access a 5G LAN VN.

Feature(s) associated with enabling the control and configuration of the CPN by an authorized administrator are provided herein.

Feature(s) associated with a network exposure function (NEF) and a local NEF (L-NEF) are provided herein.

The NEF may enable access to network information and/or capabilities for external usage (e.g., by an untrusted application function (AF) and/or application service (AS)).

The NEF may support the following functionalities (e.g., independent functionalities). The NEF may support exposure of capabilities and events. For example, NF capabilities and events may be securely exposed by the NEF to, for example, a 3rd party, AF, or Edge Computing (e.g., EAS, EES, ECS, etc.). The NEF may store and/or retrieve information as structured data using a standardized interface (e.g., a native unified data repository (Nudr)) to the unified data repository (UDR).

The NEF may support secure provision of information to the 3GPP network (e.g., from an external application): For example, the NEF may provide a means for AFs to securely provide information to the 3GPP network (e.g., expected WTRU behavior, 5G virtual network (5G-VN) group information, time synchronization service information, and/or service specific information).

The NEF may support translation of internal-external information. For example, the NEF may translate between information exchanged with the AF and information exchanged with internal NFs. For example, the NEF may handle masking of network and user sensitive information to external AF's according to the network policy.

The NEF may support redirecting the AF to a more suitable NEF/L-NEF (e.g., if the NEF is serving an AF request for local information exposure, the NEF may detect that there is a more appropriate NEF instance to serve the AF's request).

The NEF may receive information from other NFs (e.g., based on exposed capabilities of other NFs). The NEF may store the received information as structured data (e.g., using a standardized interface to a UDR). The stored information may be accessed and “re-exposed” by the NEF to other NFs and/or AFs, and/or used for other purposes (e.g., such as analytics).

The NEF may support a 5G-VN group management function. For example, the 5G-VN group management function in the NEF may store the 5G-VN group information in the UDR via unified data management (UDM).

The NEF may support exposure of analytics. For example, NWDAF analytics may be securely exposed by the NEF for external party usage (e.g., by an AF).

The NEF may support retrieval of data from an external party (e.g., an AF) by the NWDAF. For example, data provided by the external party may be collected by the NWDAF via the NEF for analytics generation purpose.

The NEF may be an entry point (e.g., a common entry point) or service access point for external communication and information-gathering to the 5GC.

A local NEF (L-NEF) is similar to the NEF, but is local to an area or CPN. For example, The L-NEF may be used in local deployments of edge services to provide network information exposure with reduced latency.

Feature(s) associated with a network data analytics function (NWDAF) are provided herein.

The NWDAF within the 5GC may be used to enable data analytics and data-based applications. The NWDAF may include one or more of the following functionalities: support data collection from NFs and AFs; support data collection from OAM; NWDAF service registration and metadata exposure to NFs and AFs; support analytics information provisioning to NFs and AFs; support machine learning (ML) model training and provisioning to NWDAFs (e.g., including an analytics logical function); and/or the like.

Feature(s) associated with a network repository function (NRF) are provided herein.

The NRF may support one or more (e.g., two) functionalities. For example, the NRF may: perform service discovery function(s) (e.g., by acting as a receiver of NF Discovery Requests from NF instances and providing the information of the discovered NF instances); maintain the NF profile of available NF instances and their supported services; and/or the like.

### Representative Procedures for Handling of Network Functions (NFs) Deployed in a Customer Premise Network (CPN)

CPNs may provide 3GPP-based control and management to customer networks within a premise (e.g., a residence, an office, a store/shop, etc.). CPNs may include a (e.g., single) point of connection to the 5GC (e.g., the enhanced Residential Gateway (eRG)), which may connect and provide access to the 5GS functionalities. The CPN may relay on the eRG when performing (e.g., all of) 5G related operations. The eRG may contain a WTRU to provide connectivity and one or more (e.g., several) NFs providing services within the CPN. The eRG may be a set of functions (e.g., NFs) that are related and residing in a single place.

The eRG may operate (e.g., jointly operate) as a conglomerate of several NFs. The NFs may be CPN-specific, may operate under a point of attachment (e.g., the same point of attachment) to the 5GC, and may be optimized concurrently. Although feature(s) described herein may be implemented in a CPN scenario, such feature(s) may apply to any situation where a set of NFs share the same network connectivity (e.g., are connected through a single WTRU to the 5GS) and share some common relationship. Feature(s) described herein may apply to one or more processes (e.g., the different 3GPP standardized processes) for registration and discovery of NFs.

In one embodiment, feature(s) associated with CPNs are provided herein.

The CPN may include an eRG. The eRG may behave as a WTRU towards the 5GC.

Within a CPN, one or more (e.g., multiple) NFs may depend on the eRG to maintain connectivity with the 5GC. One or more of the NFs may be co-located within the eRG. The NFs may be related (e.g., as they all share a common connection to the 5GC).

The CPN may be managed by an AF. The AF may not need (or may have authorization) to understand the topology of the CPN (e.g., single PRAS, multiple PRAS, AS deployment, etc.). The CPN-managing AF may be located within the CPN or may be located outside the CPN.

Feature(s) associated with optimizing different aspects of the CPN operation are provided herein. These feature(s) may be general enough to be applied in other (e.g., future) scenarios.

Feature(s) associated with an AF and/or AS interacting with the internal NFs of the eRG are provided herein. Feature(s) associated with an AF and/or AS configuring the functionalities of a CPN are provided herein.

The NFs in a CPN may have a relation (e.g., a relation between the NFs). For example, NFs may share an IP address (e.g., to optimize the interface and/or interaction between the NFs and the 5GS).

The CPN may be managed by an authorized AF (e.g., to admit devices with certain MAC addresses into a private group for communication within the CPN). The AF may (e.g., need to) understand the topology of the CPN in order to indicate where in the CPN a certain MAC address may be valid. Due to security and complexity, the CPN topology may be hidden from the authorized AF. The management interaction between an authorized AF and the CPN may be transparent to (e.g., the AF may not be aware of) the topology of the CPN.

An example eRG architecture is provided herein. Feature(s) associated with CPN-deployed NFs are provided herein.

The eRG may provide means to access information on the 5GC services (e.g., the composition of 5G-LANs). The eRG may (e.g., be able to) allow an AF belonging to an authorized administrator to configure and control parameters regarding the CPN's or eRG's operation. An authorized administrator AF may reside within the CPN (e.g., including within the eRG) or may be external to the CPN (e.g., in the core network or data network).

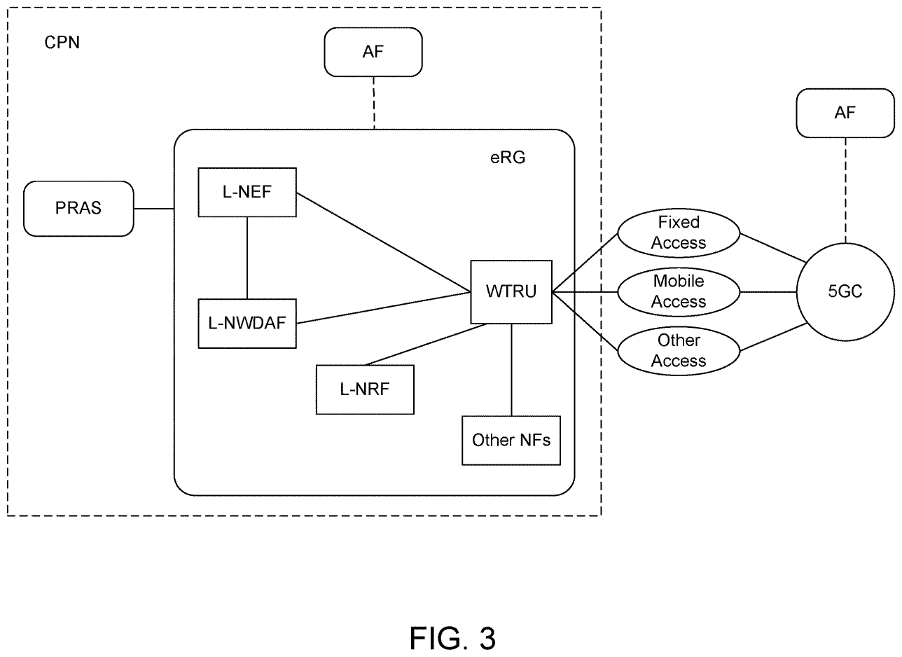

In one embodiment, referring to FIG. 3, an example eRG architecture (e.g., including CPN-deployed local NFs) is provided. The eRG may be associated with a WTRU. For example, the eRG may include a WTRU (sometimes referred to herein as the eRG WTRU). The eRG WTRU may provide a common connection to the 5GC for the CPN, including the local NFs (e.g., including a local network registration function (L-NRF), local network exposure function (L-NEF), local network data analytics function (L-NWDAF), and/or the like).

The L-NRF may serve as a local rendezvous place for local NFs.

The L-NEF may be a network exposure function of the eRG. The L-NEF may enable an AF to control, configure, and/or obtain exposed information from the eRG and PRAS. Although the AF in FIG. 3 is illustrated as external to the eRG, a person of ordinary skill in the art will understand that the AF may be co-located with the eRG.

The L-NWDAF may gather information from: the eRG (e.g., about its operation); CPN devices (e.g., including the PRAS, for example, radio information); and/or local NFs and AFs deployed in the CPN (e.g., with the eRG or connected CPN device).

The L-NWDAF may gather information through the L-NEF (e.g., as illustrated in FIG. 3), or by direct connection. The information gathered by the L-NWDAF may be exposed locally (e.g., by the L-NEF) to CPN NF(s) and AF(s).

In an example, as illustrated in FIG. 3, the L-NEF, L-NWDAF, and L-NRF may be co-located in the eRG. These NFs and other NF(s) and/or AF(s) may be deployed on other devices connected in the CPN.

In this architecture, an NF (e.g., any NF, including the L-NEF, L-NWDAF, and L-NRF) may depend on the eRG WTRU for connectivity to the 5GC (e.g., may depend on the eRG WTRU to act as a gateway with the network, for example described herein).

NFs within the CPN (e.g., including NFs that are co-located with an eRG) may not be able to register into the 5GC or global NRF until the eRG has gained connectivity. If the eRG implements IP connectivity to the CPN through a NAT, the NFs co-located with the eRG may be reachable by different IP addresses from nodes inside or outside the CPN (e.g., private address for nodes inside the CPN, public address for nodes behind the eRG). The L-NRF, global NRF, L-NEF, and global NEF (e.g., located in the core network) may include different information regarding the contact point of the NFs. The L-NEF/L-NRF may provide local IP addresses (e.g., may be from a private IP space) to local CPN NFs, while the NFs located at the core will be provided with the global IP address used by the NAT (e.g., located at the eRG) that is giving access to the CPN.

Feature(s) associated with network function repository services are provided herein. Feature(s) associated with NF group-based registration, update, and notifications are provided herein.

An eRG may contain one or more (e.g., multiple) NFs collocated or accessible within a local network (e.g., where the CPN is used as an example herein). One or more (e.g., each) of the NFs may be accessible through the same IP address (e.g., although the NFs may use different ports or may be accessible through different IP addresses belonging to the same IPv6 prefix (a prefix delegated by the 5GC to the eRG)).

CPN NFs may share one or more common parameters. A group or relation may be formed between a set of CPN NFs and their common parameters (e.g., the FQDN of the eRG). Such parameter sharing may establish a relation or grouping between the CPN NFs and their common parameters (e.g., all NFs are accessible through the same IP or same eRG). The parameter sharing and/or relation/grouping may be signaled to the network.

The relation/grouping may be used to optimize the CPN NF registration, updates, and event notifications. For example, if the NRF knows the NFs collocated with an eRG, and the eRG changes its IP address, the NRF may automatically propagate the changes across all NFs collocated with the eRG.

Defining relations/groupings between the different NFs may be applicable to any NF in the 5GC system, including use outside or beyond the CPN.

The relation between the NFs inside a CPN may be indicated in a NFGroupProfile data structure that may be used within a Nnrf_NFManagement service through an endpoint (e.g., a newly defined endpoint referred to as the nfgroup-instances). Table 1 illustrates an example of the NFGroupProfile data structure.

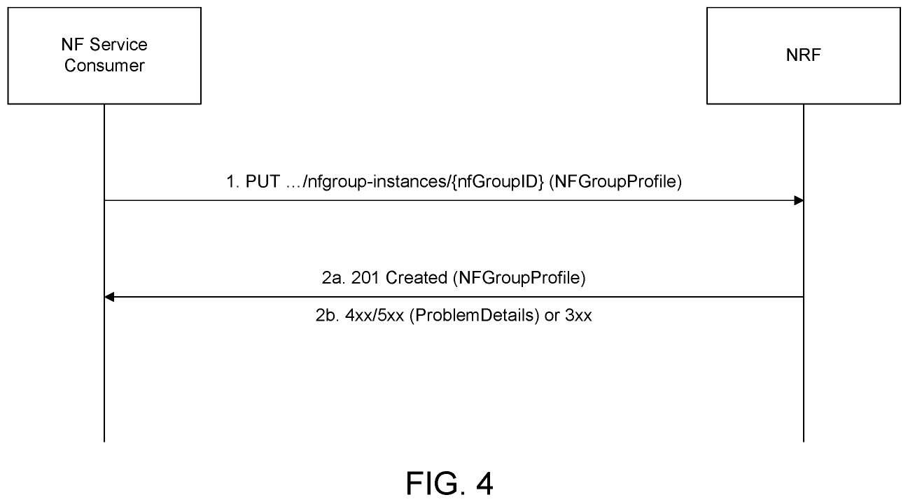

In one embodiment, referring to FIG. 4, an example procedure of NF group registration is provided.

In a CPN context, NF group registration may apply to user plane communication between the eRG in the CPN and the 5GC. The NF group registration may be used if the eRG is registered to the 5GC and has a PDU session established for communication.

NF group registration may include one or more of the following.

An NF (e.g., one of the NFs) belonging to the group of NFs (e.g., statically configured as belonging to the group) may send a PUT request to the resource URI representing the NF group instance. The URI may be determined based on the NF group instance. The variable {nfGroupID} may represent an identifier (e.g., provided by the NF service consumer). The variable {nfGroupID} may be globally unique inside the PLMN of the NRF where the NF group is being registered.

The format of the NF group ID may be a universally unique identifier (UUID), or any other unique identifier.

The payload body of the PUT request may include a representation of the NF group to be registered.

The NFs may decide which NF sends the initial PUT request. Mechanisms for arbitration may be applied (e.g., the NF with the highest ID (in numeric format) may send the initial PUT request), or the decision may be made based on configuration.

If the service consumer is not a trusted NF, the service consumer may communicate with the NEF (e.g., instead of the NRF).

If the NF group registration is successful, a message (e.g., “201 Created”) may be returned. The payload body of the PUT response may include the representation of the created resource. The “Location” header may include the URI of the created resource.

If the NF group registration fails or is redirected, one or more of the following actions may be taken. If the registration of the NF group fails at the NRF due to errors in the encoding of the NFGroupProfile JSON object, the NRF may return a message (e.g., “400 Bad Request”) that includes a status code with a ProblemDetails information element (IE) providing details of the error.

If the registration of the NF group fails at the NRF due to NRF internal errors, the NRF may return a message (e.g., “500 Internal Server Error”) that includes a status code with the ProblemDetails IE providing details of the error.

If the NF group registration is redirected, the NRF may return a “3xx” status code that may include a Location header with a URI pointing to the endpoint of another NRF service instance.

Referring back to FIG. 3, the system diagram illustrates an example eRG architecture implemented within a CPN. In this example, the CPN (or eRG) includes an L-NRF. Local CPN NFs may register to the L-NRF. The L-NRF may be the NF in charge of registering the group of NFs in the global NRF located in the core of the network.

Based on completing the group registration, the NRF may proceed to register one or more (e.g., each) of the NFs identified in the group.

To gather information regarding the registration of the NFs (e.g., each of the NFs), the NF in charge of registering the group in the global NRF (e.g., the L-NRF) may subscribe to the registration events for the NFs in the group (e.g., using the NFStatusSubscribe service of the NRF). The NF may subscribe by using the subscrCond attribute of the SubscriptionData object type, including the identifier of the group in the NfGroupListCond attribute of the SubscrCond data type.

If the NF successfully subscribes to the registration events of the NF group, the L-NRF may receive notifications of the registration of one or more NFs (e.g., each NF) in the group. The NFs in the group may get updates on their status by subscribing to such notifications in the L-NRF.

An example of the NFGroupProfile data structure is illustrated in Table 1.

TABLE 1
NFGroupProfile data structure

| Attribute name | Data type | P | Cardinality | Description |
|---|---|---|---|---|
| groupId | NfGroupId | M | 1 | Identity of the group. In the case |
| | | | | the group resides in a CPN, this |
| | | | | groupId may be equal to the CPN |
| | | | | ID. |
| nfInstanceIds | Array(NfInstanceId) | M | 1 . . . N | List of identities of the NFs |
| | | | | belonging to the group |
| commonIPv4 | array(Ipv4Addr) | O | 1 . . . N | IPv4 addresses common to the |
| | | | | group of NFs |
| port_Map | array(PortMap) | O | 1 . . . N | Array of PortMap structures |
| | | | | indicating the mapping between |
| | | | | local ports and global ports in case |
| | | | | of NAT. |
| commonIPv6 | array(Ipv6Addr) | O | 1 . . . N | IPv6 addresses common to the |
| | | | | group of NFs |
| locality | string | O | 0 . . . 1 | Operator defined information |
| | | | | about the location of the NF |
| | | | | instance (e.g., geographic |
| | | | | location, data center) |
| NFProfiles | array(NFProfile) | O | 0 . . . N | NFProfiles of the NFs forming the |
| | | | | group. The NFProfiles may be |
| | | | | used to register the NFs directly |
| | | | | while registering the group. |

Table 2 illustrates an example PortMap structure.

TABLE 2
PortMap structure

| Attribute | | | | |
|---|---|---|---|---|
| name | Data type | P | Cardinality | Description |
| Transport | TransportProtocol | C | 1 | Transport protocol |
| Local Port | Integer | C | 1 | Port number |
| External Port | Integer | C | 1 | Port number |

The NFGroupProfile data structure may be modified (e.g., through the different functions of the Nnrf_NFManagement service). Based on the grouping of NFs, one or more (e.g., all of the) NFs may be modified as a group. For example, if the eRG changes IP addresses, the collocated NFs (e.g., all of the collocated NFs) may modify their IP addresses through an exchange (e.g., a single exchange).

The PortMap structure may indicate the mapping of port numbers to the NRF (e.g., if NAT traversal is needed). The IpEndPoint included in the NFService structure within the NFProfile and/or NFGroupProfile may be mapped to an URL accessible from outside the local network.

Feature(s) associated with proxy-registration (e.g., by an AMF) of CPN NFs connected via an eRG are provided herein.

NFs (e.g., all NFs) located within the CPN may depend on the eRG connectivity to register with the NRF and 5GC. The registration process of the NFs may (e.g., need to) wait until the eRG (e.g., eRG WTRU) registers with the 5GS and obtains an IP address (e.g., via PDU session establishment).

The eRG WTRU may be the entity in the eRG that provides connectivity to the core network (e.g., 5GC). Communication by the eRG with the network described herein may be performed by the eRG WTRU. WTRUs may be different from NFs and may not be intended to run or implement the APIs used for NFs to register and connect to the core. However, in a CPN, local NFs may (e.g., need to) register and communicate with the 5GC via the eRG WTRU.

The eRG (e.g., eRG WTRU) may indicate to the AMF the NFs located within the CPN (e.g., including itself (eRG)). The eRG may request that the AMF proxy-register the CPN local NFs with the NRF (e.g., via the eRG WTRU control plane). The CPN NF proxy-registration may occur before or after the eRG WTRU establishes a PDU session and receives an IP address from the SMF/UPF. If the CPN NF proxy registration is initiated before the eRG obtains an IP address, the AMF may not complete the proxy registration of the CPN NFs with the NRF until an eRG WTRU PDU session is established.

An IE (e.g., illustrated in Table 3) may be added to a registration request message

TABLE 3
Example IE within a registration request message

| | Information | | | | |
|---|---|---|---|---|---|
| IEI | Element | Type Reference | Presence | Format | Length |
| TBD | eRG | eRG | O | TV | Min 4 |
| | capabilities | capabilities | | | octets |

The IE may be a 5GS mobility management (5GMM) information element (e.g., such as an eRG capability IE).

The eRG capability IE may provide the network with information associated with aspects of the eRG related to the NFs collocated with the eRG or in the CPN. The eRG capability IE may indicate aspects of the eRG's operation (e.g., such as the presence of a NAT connecting the CPN to the eRG). The contents of the eRG capability IE may affect the manner in which the network handles the operation of the eRG.

The eRG capability IE may be coded, as illustrated in Table 42.

TABLE 4
An example eRG capability IE

| 8 | 7 | 6 | 5 | 4 | 3 | 2 | 1 | |
|---|---|---|---|---|---|---|---|---|
| eRG capability IEI | | | | | | | | octet 1 |
| Length of 5GMM capability contents | | | | | | | | octet 2 |
| Configur- | Offloading to | Local DNN | CPN with | CPN with | Use of | Visitor | Implements | octet 3 |
| able CPN | CPN | | UPF | Relay | unlicensed | access | NAT | |
| | | | | | spectrum | support | | |
| Local NEF | Local | Local | Supports | Supports | Split DNN | Dynamic | NFProfile | octet 4 |
| | NWDAF | N3IWF | N5CW | N5GC | | DNS | sent in | |
| | | | | | | | transport | |

The eRG capability IE may have a minimum length of four (4) octets and a maximum length of fifteen (15) octets.

The “Configurable CPN Name” bit may indicate (e.g., to the 5GC) whether the eRG is capable of supporting configurable CPN names. One or more CPN_Name bits may be used to enable different services and service levels for a CPN_Name (e.g., each CPN_Name).

The “Offloading to CPN” bit may indicate whether the eRG is capable of offloading incoming traffic to a local UPF.

The “Local DNN” bit may indicate whether the eRG is capable of connecting to local or external IP networks via the eRG.

The “CPN with UPF” bit may indicate whether the eRG is capable of performing CPN communication that allows the eRG to switch the traffic originating from WTRUs behind the eRG to local UPF.

The “CPN with relay” bit may indicate whether the eRG is capable of performing CPN communication that allows the eRG to relay the traffic originating from WTRUs behind the eRG to 5GC.

The “Use of unlicensed spectrum” bit may indicate whether the eRG is capable using the unlicensed spectrum within the PRAS(s) connected to the eRG.

The “Visitor access support” bit may indicate whether the eRG/PRAS supports access for all visitors, no visitors, or specific visitors (e.g., only specific visitors). The Visitor access support capability may be preconfigured by an authorized administrator (e.g., subject to operator's policy).

The “Implements NAT” bit may indicate whether the CPN is behind a NAT.

The “Local NEF” bit may indicate whether the eRG implements a collocated Local-NEF.

The “Local NWDAF” bit may indicate whether the eRG implements a collocated Local-NWDAF.

The “Local N3IWF” bit may indicate whether the eRG is capable of allowing untrusted non-3GPP access users to connect to 5GC via the eRG.

The “Supports N5CW” bit may indicate whether the eRG implements a Local-TWIF.

The “Supports N5GC” bit may indicate whether the eRG implements W-AGF functionality to register N5GC nodes in the CPN.

The “Split DNN” bit may indicate whether the CPN is split across multiple locations connected through different eRGs.

The “Dynamic DNS” bit may indicate (e.g., to the AMF) whether the eRG and collocated NFs will automatically update their DNS entry based on IP information (e.g., received IP information).

The “NFProfile sent in transport” IE may indicate whether the eRG will provide (e.g., later provide) the NFProfile/NFGroupProfile of the different NFs to be proxy-registered by the AMF into the NRF.

The “eRG functionality” IE and “Proxy NF registration” IE may be included in the register request (e.g., if the 5GMM capabilities IE indicates the support of eRG). Table 5 illustrates an example modified 5GMM Capability IE (e.g., that includes the eRG functionality IE and the Proxy NF registration IE, highlighted below).

TABLE 5
Example modified 5GMM capability IE.

| 8 | 7 | 6 | 5 | 4 | 3 | 2 | 1 | |
|---|---|---|---|---|---|---|---|---|
| 5GMM capability IEI | | | | | | | | octet 1 |
| Length of 5GMM capability contents | | | | | | | | octet 2 |
| SGC | 5G-IPHC-CP | N3 data | 5G-CP | RestrictEC | DPP | HO attach | S1 mode | octet 3 |
| | CloT | | CloT | | | | | |
| RACS | NSSAA | 5G-LCS | V2XC | V2XC EPC5 | V2X | 5G-UP CloT | 5GSR VCC | octet 4 |
| | | | NPC5 | | | | | |
| ProSel2relay | ProSe-dc | ProSedd | ER- | 5G-EHC- | multipleUP | WUSA | CAG | octet 5 |
| | | | NSSAI | CP-CloT | | | | |
| PR | RPR | PIV | NCR | NR-PSSI | ProSel3rmt | ProSel2rmt | ProSel3relay | octet 6 |
| eRG | Proxy NF | Spare | Ex- | SSNP NSI | Event | MINT | NSSR | octet 7 |
| functionality | registration | | CAG | | Notification | | | |
| 0 | 0 | 0 | 0 | 0 | 0 | 0 | 0 | octet 8-15 |

The 5GMM capability IE may include (e.g., include bit(s) that indicate) an eRG functionality IE that may indicate (e.g., to the AMF) that the WTRU registering is an eRG. The eRG functionality IE may indicate that an eRG capability IE is included in the (e.g., same) registration request.

The 5GMM capability IE may include a Proxy NF registration IE that may indicate the eRG/WTRU is requesting the AMF to proxy-register the collocated NFs in the NRF.

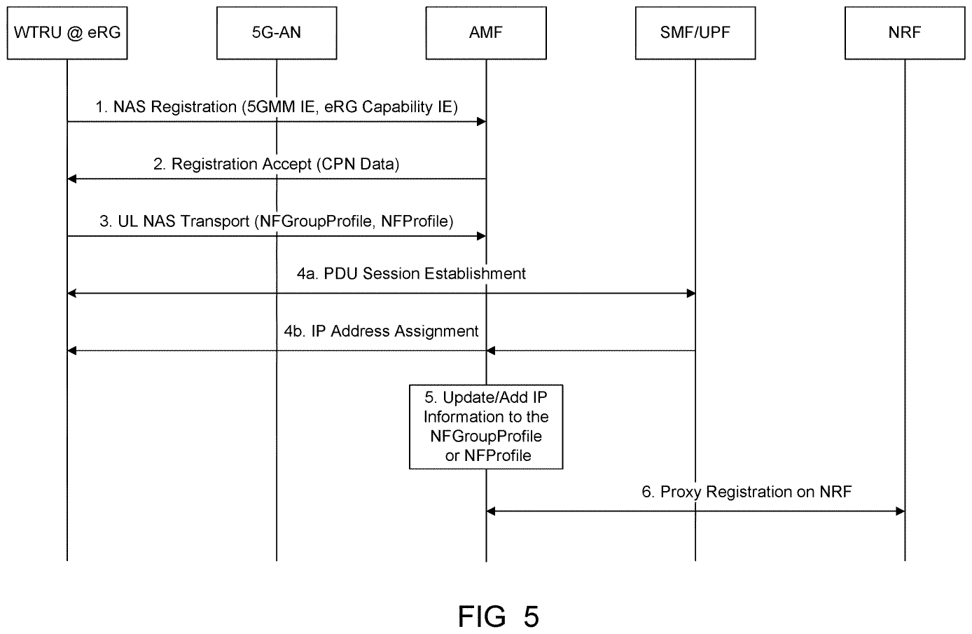

In one embodiment, referring to FIG. 5, an example procedure of a proxy registration of CPN-deployed NFs via an AMF is provided.

The eRG may behave like a WTRU for the 5GC or 5G system. The eRG may perform registration towards the AMF, for example, the eRG WTRU may perform registration (e.g., which may comprise proxy registration of NFs) towards the AMF as illustrated in FIG. 5). The eRG may indicate that the eRG is providing access to a CPN by setting the eRG functionality IE (e.g., bit) in the 5GMM capability IE (e.g., setting the eRG functionality IE to 1). The eRG may send the eRG capability IE with information associated with the eRG and CPN. In the eRG capability IE, the eRG may indicate the different NFs that are collocated with the eRG. In the eRG capability IE, the eRG may indicate its capability by sending the NFProfile/NFGroupProfile of the collocated NFs through a NAS transport message. The eRG may request that the AMF perform proxy registration of the NFs that are collocated with the eRG. The profile(s) of the NFs that are collocated with the eRG may be sent in the NAS Transport (e.g., through the use of the Proxy NF registration IE (bit) included in the 5GMM capability IE).

The AMF may accept the registration of the eRG. The AMF may provide information such as, for example, the eRG ID and policies to be used by the eRG.

The eRG WTRU may provide the NFProfiles or the NFGroupProfile data structures to be used by AMF to register the NFs into the NRF. The eRG may provide this information at any time after the registration of the eRG. For example, FIG. 5 illustrates the eRG providing the information before PDU session establishment. If the eRG provides the information before PDU session establishment (e.g., as shown in FIG. 5), the AMF may not complete the proxy NF registration with the NRF until after the eRG is assigned an IP address. If a PDU session is already established (e.g., the eRG is assigned an IP address) when the eRG provides the information, the AMF may register the CPN NFs with the NRF (e.g., without performing the actions described at 4a, 4b, and 5).

The WTRU may send an uplink NAS transport message. The uplink NAS transport message may include, for example, an Additional Information IE (e.g., or other Es may transport this information) with the different NFGroupProfile(s) or NFProfile(s) to proxy-register with the NRF. Feature(s) associated with transporting the NFGroupProfile or NFProfile in an uplink NAS transport message are provided herein.

The eRG WTRU may know that CPN NF proxy registration may be triggered by: eRG configuration that indicates a trigger condition (e.g., CPN NF registration at eRG registration time); policies provided by the AMF (e.g., as described at 2 in FIG. 5) that may indicate if Proxy Registration is requested, allowed, or prohibited, and conditions that trigger registration; detecting that a new NF instance is available in the CPN (e.g., NF registration with the L-NRF in the CPN); and/or detecting that an NF instance was removed from the CPN.

If the eRG has established a PDU session, the eRG may communicate the CPN NF proxy-registration with the 5GC NRF via the user plane (e.g., instead of via the eRG control plane).

The eRG may obtain one or more IP address(es) to use to register the NFs collocated with the eRG. For example, as shown at 4a, the eRG may establish a PDU session with the SMF and may be assigned a UPF. the eRG may receive an IP address (e.g., as part of establishing the PDU session). As shown at 4b, the SMF may send the IP address to the eRG through the AMF.

If the uplink NAS transport message is transmitted before the SMF allocated the IP address to the eRG, the AMF may (e.g., after receiving the eRG IP address information) use the eRG IP address information to update the NFProfiles or NFGroupProfiles provided by the eRG. If the uplink NAS transport message was not transmitted before the SMF allocated the IP address to the eRG, the NFProfiles or the NFGroupProfile may (e.g., may already) include the IP address.

The AMF may perform the proxy-registration of the collocated NFs with the eRG towards the NRF (e.g., by utilizing the Nnrf_NFManagement Service or by utilizing NF Group registration described herein). If the proxy-registration is completed, the NFs (e.g., which may be locally deployed in the CPN) will be registered with the NRF in the 5GC (e.g., external to the CPN). NFs that are registered with the external NRF may be discoverable by other NFs. For example, an NF or AF that is not within the CPN may communicate with the 5GC NRF to discover information about one or more of the NFs that are locally deployed in the CPN (e.g., including those collocated with the eRG). The discovered information may include any of the information from Table 1. For example, the discovered information may include an address (e.g., IP Address, Port Number, and/or URI) of one or more of the NFs that are locally deployed in the CPN. The NF that is not within the CPN may use the discovered information to send a message to the Local CPN NF. The message may be received by the eRG and forwarded to the NF that is locally deployed in the CPN.

The NFGroupProfile(s) or NFProfile(s) may be transported between the WTRU and the AMF through the uplink NAS transport message. The NFGroupProfile(s) or NFProfile(s) may be transported using an Additional Information IE. In this case, the NFGroupProfiles or NFProfiles may be sent within the IE (e.g., the already defined IE). The IE may indicate that the IE includes the NFGroupProfiles or NFProfiles parameters through bits included in the 5GMM capability IE.

The NFGroupProfile(s) or NFProfile(s) may be transported using a container (e.g., a new container) within the uplink NAS transport message. In this case, the uplink NAS transport message may be modified as follows:

TABLE 6
An example uplink NAS transport message

| | Information | | | For- | |
|---|---|---|---|---|---|
| IEI | Element | Type/Reference | Presence | mat | Length |
| | Extended | Extended | M | V | 1 |
| | protocol | protocol | | | |
| | discriminator | discriminator | | | |
| | | 9.2 | | | |
| . . . | | | | | |
| TBD | NFGroupProfile | NFGroupProfile | O | TLV | 3-65537 |
| | container | container TBD | | | |
| TBD | NFProfile | NFProfile | O | TLV | 3-65537 |
| | container | container TBD | | | |

The NFGroupProfile Container IE may be defined as follows:

TABLE 7
An example NFGroupProfile Container IE

| | | | | | | | |
|---|---|---|---|---|---|---|---|
| 8 | 7 | 6 | 5 | 4 | 3 | 2 | 1 |

| | |
|---|---|
| NFGroupProfile container IEI | Octet 1 |
| Length of NFGroupProfile container contents | Octet 2-3 |
| NFGroupProfile container contents | Octet 4-n |

The NFGroupProfile container information element may be a type 6 IE with a minimum length of 4 octets and a maximum length of 65538 octets.

The NFGroupProfile container contents field may include an NFGroupProfile structure (e.g., as shown in Table 1).

The NFProfile container IE may have the following structure:

TABLE 8
Example structure of an NFProfile container IE

| | | | | | | | |
|---|---|---|---|---|---|---|---|
| 8 | 7 | 6 | 5 | 4 | 3 | 2 | 1 |

| | |
|---|---|
| NFProfile container IEI | Octet 1 |
| Length of NFProfile container contents | Octet 2-3 |
| NFProfile container contents | Octet 4-n |

The NFProfile contents field may have the following structure:

TABLE 9
Example structure of an NFProfile contents field

| | | | | | | | |
|---|---|---|---|---|---|---|---|
| 8 | 7 | 6 | 5 | 4 | 3 | 2 | 1 |

| | |
|---|---|
| Number of NFProfiles included | Octet 4 |
| NFProfile 1 | Octet 5-n |
| NFProfile 2 | Octet n-m |
| . . . | . . . |
| NFProfile N | . . . |

The NFProfile container information element may be a type 6 IE with a minimum length of 4 octets and a maximum length of 65538 octets. The NFProfile container IE may include the list of NFProfiles that are to be registered.

The NFGroupProfile(s) or NFProfile(s) may be transported using the payload container in the uplink NAS transport message. The payload container may include (e.g., as an optional IE) the NFGroupProfile IE or NFProfile IE in a payload container entry.

Feature(s) associated with enhancements to NFProfile to support split CPNs are provided herein.

A CPN may be (e.g., may be depicted as) a simple residential network encompassing an (e.g., one single) eRG connecting the CPN (e.g., the whole CPN) to the 5GC. A CPN may be more complex (e.g., spanning through multiple locations and Data Networks (DNs)). CPNs may be configured and managed by a local AF, which may need to interact with the eRG and the 5GC.

An NEF or L-NEF may be discovered using a DNS query using the external identifier of a WTRU (e.g., an individual WTRU). The AF/AS may need to know that the CPN is split. The AF/AS may need to know the identifiers of each WTRU (e.g., eRG WTRU) connecting to the AF/AS. If the AF is located inside the CPN, the IP bundled to the external identifier may not be reachable from the internal CPN network (e.g., the eRG may provide a NAT function and the external ID maps to the external IP).

Configuration of the CPN may be performed by an external AF through a local NEF (e.g., which will expose the APIs and information needed to configure the local segment and its interaction with the 5GC). CPNs may span across multiple locations, and may include multiple eRGs. In this case, the AF may not be able to understand which L-NEF to access to configure a specific segment of the CPN.

The NFProfile may be extended to consider a relation between the NF and the eRG, DNN, and location. The AF may be able to discover the most appropriate L-NEF with which to communicate (e.g., including any possible hierarchy or priority among the local NFs).

The following information may be added to the NFProfile data type:

TABLE 10
Example information in an NFProfile IE

| Attribute | | | | |
|---|---|---|---|---|
| name | Data type | P | Cardinality | Description |
| CPN info | CPN | O | 1 | Information of the |
| | Information | | | CPN network |

The CPN Information may include one or more of the following components:

TABLE 11
Example components of CPN information

| Attribute name | Data type | P | Cardinality | Description |
|---|---|---|---|---|
| CPN ID | String | M | 1 | ID of the CPN |
| eRG ID | Array(String) | M | 1 . . . N | IDs of the eRG used to reach this NF |
| List of DNNs | Array(DNN) | M | 1 . . . N | List of DNNs connected to this NF |
| List of related NFs | Array(NfInstanceId) | O | 1 . . . N | List of other NFs of the same type |
| | | | | providing services to the CPN |
| Priority | Integer | O | 1 | Priority within this type of NF in this |
| | | | | CPN |
| Location | String | O | 1 | Information about the location of the |
| | | | | CPN (or part of it) served by this NF |
| CPN ID | String | M | 1 | ID of the CPN |

The NRF may use this information to select an NF (e.g., L-NEF) for the AF to use to control and/or configure the CPN.

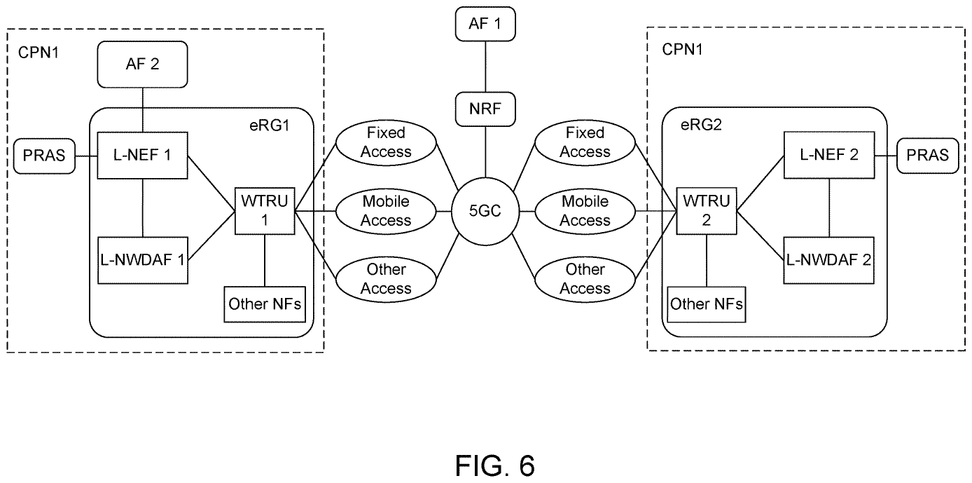

Referring to FIG. 6, an example of a split CPN architecture is provided. The CPN may be a CPN of, for example, a small enterprise/company, which connects two distinct locations. A first AF (AF1) may attempt to configure the CPN (e.g., AF1 may belong to a remote administrator of the small enterprise/company). The CPN may be configured such that the AAA server for the company (e.g., the whole enterprise/company) is located in eRG2. To configure AAA parameters, AF1 may (e.g., may need to) interact with a local NF of eRG2 (e.g., L-NEF2).

If the NRF decides an L-NEF to provide to the AF, or if the AF receives the information of both L-NEFs, the NRF or AF may consider the priority, location, eRG ID, etc., of the parameters added to the CPN Information data type (e.g., described herein with respect to Table 10). For example, the NRF or AF may determine that there are two L-NEFs serving the CPN, and that the L-NEF with higher priority is the L-NEF in eRG2 (e.g., L-NEF2).

A first WTRU (e.g., WTRU1) may be associated with (e.g., may comprise) a first eRG (e.g., eRG1) of the split CPN. A second WTRU (e.g., WTRU2) may be associated with (e.g., may comprise) a second eRG (e.g., eRG2) of the split CPN.

A second AF (AF2) may attempt to access the L-NWDAF located in eRG1. Based on the information associated with eRG1 provided in the CPN Information data type, the NRF or AF2 may select the correct L-NWDAF.

### Representative Procedure for Proxy Registration of CPN NFs Connected Via eRG by AMF

In one embodiment, a wireless transmit/receive unit (WTRU) for wireless communications comprising circuitry, including a processor, a transmitter, a receiver, and memory is provided. The WTRU sends (to an AMF) a first registration message indicating a request for the AMF to proxy register a network function (NF) or an NF group associated with the WTRU. The WTRU receives (from the AMF) a second registration message indicating proxy registration information based on the first registration message. The WTRU sends (to the AMF) a message indicating NF profile information of the NF or the NF group associated with the WTRU. In an example, the WTRU is associated with a customer premise network (CPN), and the CPN comprises an evolved residential gateway (eRG) and a premises radio access station (PRAS). The first registration message may comprise a 5G mobility management (5GMM) IE. The WTRU may be associated with an evolved residential gateway (eRG) or a customer premise network (CPN). In an example, the message indicating the NF profile information is an uplink non-access stratum (NAS) transport message.

### CONCLUSION

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

1. A method implemented by a wireless transmit/receive unit (WTRU), the method comprising:
sending, to an access and mobility management function (AMF), a first registration message indicating a request for the AMF to proxy register a network function (NF) or an NF group associated with the WTRU;
receiving, from the AMF, a second registration message indicating proxy registration information based on the first registration message; and
sending, to the AMF, a message indicating NF profile information of the NF or the NF group associated with the WTRU.

2. A wireless transmit/receive unit (WTRU) for wireless communications, comprising circuitry, including a processor, a transmitter, a receiver, and memory, the WTRU configured to:
send, to an access and mobility management function (AMF), a first registration message indicating a request for the AMF to proxy register a network function (NF) or an NF group associated with the WTRU;
receive, from the AMF, a second registration message indicating proxy registration information based on the first registration message; and
send, to the AMF, a message indicating NF profile information of the NF or the NF group associated with the WTRU.

3. The method of claim 1, wherein the WTRU is associated with a customer premise network (CPN), and wherein the CPN comprises an evolved residential gateway (eRG) and a premises radio access station (PRAS).

4. The method of claim 1, wherein the first registration message comprises a 5G mobility management (5GMM) IE.

5. The method of claim 1, wherein the WTRU is associated with an evolved residential gateway (eRG) or a customer premise network (CPN).

6. The method of claim 1, wherein the message indicating the NF profile information is an uplink non-access stratum (NAS) transport message.

7-17. (canceled)

18. A network device comprising:
a processor configured to:
receive a registration message from a wireless transmit/receive unit (WTRU), wherein the registration message indicates a request for the network device to proxy register a network function (NF) or an NF group associated with the WTRU;
send a registration accept message to the WTRU;
receive a network function (NF) profile message from the WTRU, wherein the NF profile message indicates NF profile information for the NF or the NF group associated with the WTRU;
receive an internet protocol (IP) address assignment, wherein the IP address assignment indicates IP address information associated with the WTRU;
update the NF profile information based on the IP address information; and
perform proxy registration for the NF or the NF group associated with the WTRU based on the updated NF profile information.

19. The network device of claim 18, wherein the request is for the NF group, wherein the NF group is a plurality of NFs, wherein the NF profile message indicates the NF group, wherein the NF profile message further indicates a parameter that is common to the plurality of NFs in the NF group.

20. The network device of claim 19, wherein the parameter comprises at least one of: a fully qualified domain name (FQDN) associated with the WTRU, or an IP address indicated by the IP address assignment.

21. The network device of claim 18, wherein the WTRU is associated with a split customer premise network (CPN), and wherein the NF profile message further indicates a plurality of local network exposure functions (L-NEFs) associated with the split CPN and priority information associated with the plurality of L-NEFs.

22. The network device of claim 18, wherein the NF profile message is received via an uplink non-access stratum (NAS) transport message.

23. The network device of claim 18, wherein the WTRU is associated with an evolved Residential Gateway (eRG).

24. The network device of claim 23, wherein the NF or NF group comprises one or more of: a local network registration function (L-NRF), a local network exposure function (L-NEF), or a local network data analytics function (L-NWDAF).

25. The network device of claim 18, wherein the WTRU and the NF or NF group are associated with a local network.

26. The network device of claim 25, wherein the local network is a customer premise network (CPN).

27. The WTRU of claim 2, wherein the WTRU is associated with a customer premise network (CPN), and wherein the CPN comprises an evolved residential gateway (eRG) and a premises radio access station (PRAS).

28. The WTRU of claim 2, wherein the first registration message comprises a 5G mobility management (5GMM) IE.

29. The WTRU of claim 2, wherein the WTRU is associated with an evolved residential gateway (eRG) or a customer premise network (CPN).

30. The WTRU of claim 2, wherein the message indicating the NF profile information is an uplink non-access stratum (NAS) transport message.
